(19) United States
(12) Patent Application Publication
(10) Pub. No.: US 2011/0119432 A1
(43) Pub. Date: May 19, 2011

(54) NONVOLATILE MEMORY DEVICES HAVING IMPROVED READ PERFORMANCE RESULTING FROM DATA RANDOMIZATION DURING WRITE OPERATIONS

(76) Inventor: Sangyong Yoon, Seoul (KR)

(21) Appl. No.: 12/941,414

(22) Filed: Nov. 8, 2010

(30) Foreign Application Priority Data
Nov. 19, 2009 (KR) 10-2009-0112095

(51) Int. Cl. G06F 12/02; G06F 12/00

(52) U.S. Cl. 711/103; 711/154; 711/E12.001; 711/E12.008

(57) ABSTRACT

Memory devices include an array of non-volatile memory cells and a memory control circuit. The memory control circuit, which is electrically coupled to the array of non-volatile memory cells, includes a pseudo-random data coder/decoder circuit. This pseudo-random data coder/decoder circuit is configured to convert a first block of input data to be written into the memory device into a second block of data. This second block of data is encoded as a two-dimensional pseudo-random distribution of data values, which are more uniformly distributed relative to data values in the first block of input data. The memory control circuit is further configured to write the second block of data into the array of non-volatile memory cells during a plurality of page write operations.

### REFERENCE TO PRIORITY APPLICATION

This application claims priority to Korean Patent Application No. 10-2009-0112095, filed Nov. 19, 2009, the contents of which are hereby incorporated herein by reference.

### FIELD OF THE INVENTION

The invention relates to semiconductor memory devices and, more particularly, to flash memory devices.

### BACKGROUND

A flash memory is a form of EEPROM that allows multiple memory locations to be erased or written in one programming operation. A normal EEPROM only allows one location at a time to be erased or written, meaning that a flash memory can operate at higher effective speeds when memory systems using it read and write to different locations at the same time. After a specific number of erase operations, all types of flash memories and EEPROM may wear out due to deterioration of charge storage means used to store data or wearing of an insulating layer covering the charge storage means.

A flash memory stores information on a silicon chip in a way that it does not need power to maintain the information in the chip. This means that if the supply of the power to the chip is interrupted, the information is retained without consuming any power. In addition, a flash memory offers physical shock resistance and fast read access times. These characteristics make it very popular for applications such as storage on battery-powered devices.

### SUMMARY

Memory devices according to some embodiments of the invention include an array of non-volatile memory cells, which can be arranged as a plurality of rows of non-volatile memory cells electrically coupled to respective word lines and a plurality of columns of non-volatile memory cells electrically coupled to respective bit lines. A memory control circuit is also provided. The memory control circuit, which is electrically coupled to the array of non-volatile memory cells, includes a pseudo-random data coder/decoder circuit. This pseudo-random data coder/decoder circuit is configured to convert a first block of input data to be written into the memory device into a second block of data. This second block of data is encoded as a two-dimensional pseudo-random distribution of data values, which are more uniformly distributed relative to data values in the first block of input data. The memory control circuit is further configured to write the second block of data into the array of non-volatile memory cells during a plurality of page write operations.

According to additional embodiments of the invention, the pseudo-random data coder/decoder circuit is further configured to convert the second block of data having a two-dimensional pseudo-random distribution of data values into a first block of output data during a plurality of page read operations. This first block of output data matches the first block of input data.

According to still further embodiments of the invention, the pseudo-random data coder/decoder circuit includes a pseudo-random sequence generator, which is configured to generate a pseudo-random sequence of encoding bits. In particular, the pseudo-random data coder/decoder circuit is configured to logically combine the pseudo-random sequence of encoding bits with a sequence of bits of data within the first block of input data during the plurality of page write operations. This logical combination may be performed using an XOR logic circuit, for example.

The pseudo-random sequence generator may include first and second pseudo-random sequence generators. The first pseudo-random sequence generator is configured to generate a first pseudo-random sequence of bits in response to a first clock signal and a first multi-bit seed value. The second pseudo-random sequence generator is configured to generate a second pseudo-random sequence of bits in response to a second clock signal and a second multi-bit seed value. A combinational logic circuit is also configured to generate the pseudo-random sequence of encoding bits in response to the first and second pseudo-random sequence of bits. This combinational logic circuit can be an XOR logic circuit, which receives the first and second pseudo-random sequence of bits at inputs thereof.

According to additional embodiments of the invention, the first pseudo-random sequence generator may include a first linear feedback shift register that is synchronized with the first clock signal. This first pseudo-random sequence generator may be configured to load the first multi-bit seed value into the first linear feedback shift register during generation of the first pseudo-random sequence of bits. Similarly, the second pseudo-random sequence generator may include a second linear feedback shift register, which is loaded with the second multi-bit seed value during generation of the second pseudo-random sequence of bits.

### BRIEF DESCRIPTION OF THE DRAWINGS

The inventive concept will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the inventive concept.

FIG. 1 is a block diagram of a flash memory device according to an exemplary embodiment of the inventive concept.

FIG. 2 illustrates an example of an organization of a memory cell array into memory blocks for an all bit line memory architecture or for an odd-even memory architecture.

FIG. 3 is a block diagram of a data randomizing and de-randomizing circuit shown in FIG. 1 according to an exemplary embodiment of the inventive concept.

FIG. 4 is a timing chart illustrating the operation of a first random sequence generator shown in FIG. 3.

FIG. 5 is a timing chart illustrating the operation of a second random sequence generator shown in FIG. 3.

FIG. 6 illustrates the operation of a random sequence generation unit shown in FIG. 3.

FIG. 7 is a circuit diagram of the first/second random sequence generator shown in FIG. 3.

FIG. 8 is a flowchart illustrating a program operation of a flash memory device according to an exemplary embodiment of the inventive concept.

FIG. 9 is a flowchart illustrating a read operation of a flash memory device according to an exemplary embodiment of the inventive concept.

FIG. 10 is a block diagram of a flash memory device according to another exemplary embodiment of the inventive concept.

FIG. 11 is a block diagram of an integrated circuit card including a flash memory device according to an exemplary embodiment of the inventive concept.

FIG. 12 is a block diagram of a computing system including a flash memory device according to an exemplary embodiment of the inventive concept.

FIG. 13 is a block diagram of a memory system according to another embodiment of the inventive concept.

### DETAILED DESCRIPTION OF THE EMBODIMENTS

The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept.

In the drawings, embodiments of the inventive concept are not limited to the specific examples provided herein and are exaggerated for clarity. Furthermore, the same reference numerals denote the same elements throughout the specification.

As used herein, the term “and/or” includes any and all combinations of one or more of the associated listed items. It will be understood that when an element is referred to as being “connected” or “coupled” to another element, it may be directly connected or coupled to the other element or intervening elements may be present. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

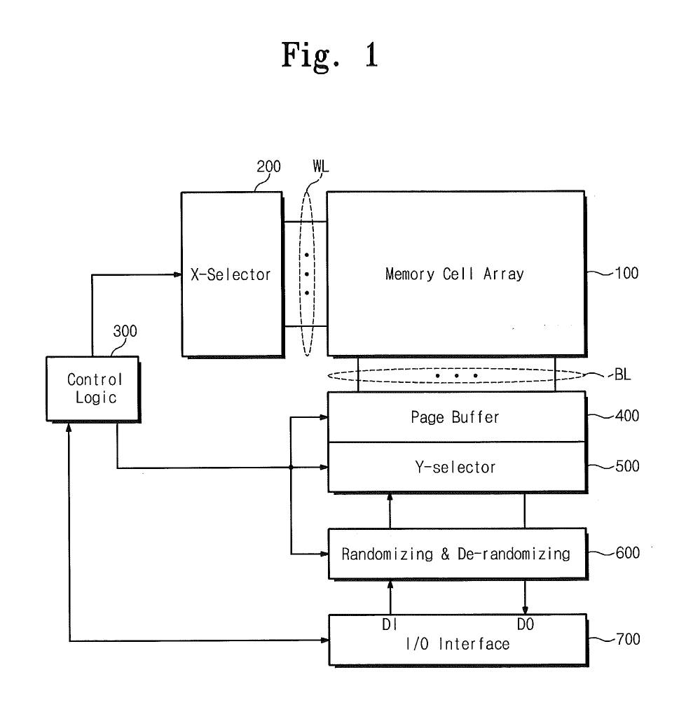

FIG. 1 is a block diagram of a flash memory device according to an exemplary embodiment of the inventive concept. Referring to FIG. 1, the flash memory device is, for example, a NAND flash memory device. The flash memory device includes a memory cell array 100 including memory cells arranged in a matrix of rows (word lines WL) and columns (bit lines BL). Each of the memory cells stores 1-bit data or M-bit data (M being 2 or greater). Each of the memory cells may be configured using a memory cell including a charge storage layer such as a floating gate or a charge trapping layer or a memory cell including a variable resistance element. The memory cell array 100 may be configured to have a single-layer array structure (or called a two-dimensional array structure) or a multi-layer array structure (or called a three-dimensional array structure).

A row selector (X-Selector) 200 is controlled by a control logic 300 and configured to perform selecting and driving operations for rows of the memory cell array 100. The control logic 300 is configured to control an overall operation of the flash memory device and functions as a sense amplifier or a write driver according to an operation mode. For example, during a read operation, a page buffer circuit 400 functions as a sense amplifier sensing data from memory cells of a selected row. During a program operation, the page buffer circuit 400 functions as a write driver driving memory cells of a selected row according to program data. The page buffer circuit 400 includes page buffers corresponding to each of bit lines or bit line pairs. When respective memory cells store multi-bit data, respective page buffers of the page buffer circuit 400 may be configured to have two or more latches.

Continuing to refer to FIG. 1, a column selector (Y-selector) 500 is controlled by the control logic 300 and selects columns (or page buffers) in a predetermined sequence. A data randomizing and de-randomizing circuit 600 is configured to randomize data transferred through an input/output interface 700 (i.e., data to be programmed) in compliance with the control of the control logic 300. The randomizing and de-randomizing circuit 600 is configured to de-randomize data of the page buffer circuit 400 transferred through the column selector 500 in compliance with the control of the control logic 300. The randomizing and de-randomizing circuit 600 according to an exemplary embodiment of the inventive concept pseudo randomizes data to be programmed such that randomization of data stored in the memory cell array 100 is performed in both a string direction (or column direction) and a word line direction (or row direction).

According to the above-described data randomizing manner, states of memory cells along rows (i.e., memory cells connected to respective word lines) may be approximately uniformly distributed, and states of memory cells along columns (i.e., memory cells along respective strings) may also be uniformly distributed. Since the states of memory cells along the respective strings are approximately uniformly distributed, a read operation margin may be improved. Cell current flowing through a selected memory cell during a read operation may be affected by states of memory cells (upper memory cells) disposed between a selected memory cell and a bit line (hereinafter, each of the states being referred to as “back pattern”).

For example, it is assumed that respective memory cells have one of four states, i.e., an erase state (E) and program states (P1, P2, and P3), selected memory cells of respective strings connected to a selected word line have the first program state (P1), and back patterns to selected memory cells of respective strings are different from each other. According to the assumption, currents flowing through channels of memory cells constituting a back pattern may are different from each other at respective strings. This means that although selected memory cells have the same state, cell currents flowing through the selected memory cells are different from each other. Moreover, common source line noises that the selected memory cells encounter are also different from each other. Due to back pattern and noise, a threshold voltage of a memory cell may become higher or lower than its desired programmed state during a read operation. As a result, a threshold voltage distribution may be broadened to thereby reduce a reading margin. However, the states of the memory cells along columns may be approximately uniformly distributed because the data randomization is performed in not only the row direction but also the column direction (string direction). This means that a back pattern may be similarly or identically formed at the respective strings. For this reason, the reading margin may be improved.

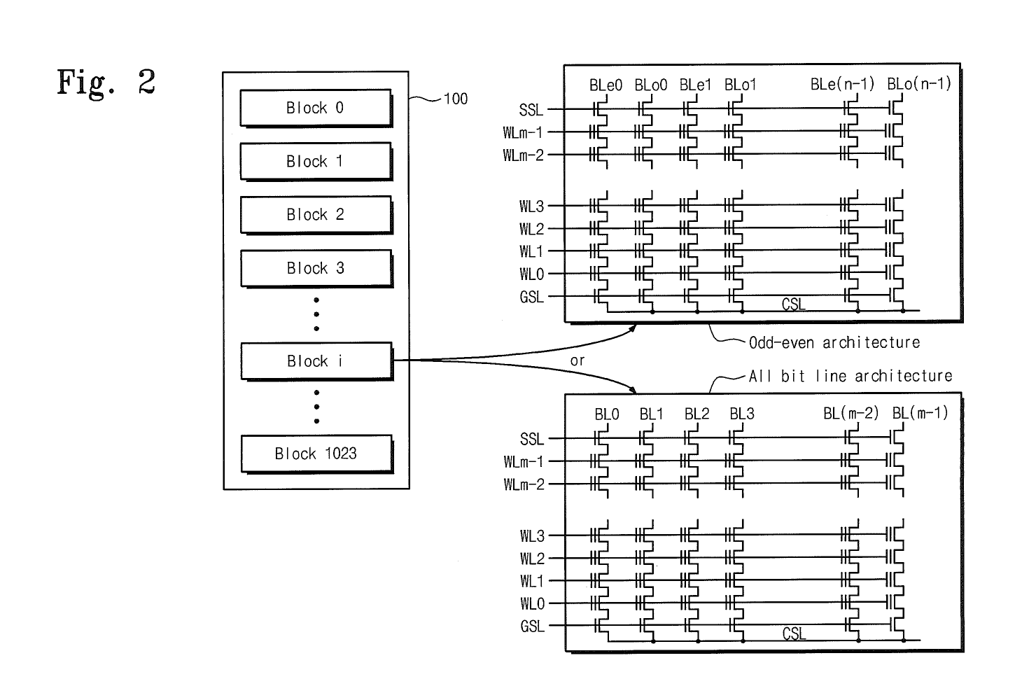

FIG. 2 illustrates an example of an organization of a memory cell array into memory blocks for an all bit line memory architecture or for an odd-even memory architecture. Exemplary structures of a memory cell array will be described. As one example, a NAND flash memory including a memory cell array 100 partitioned into 1,024 blocks will now be described. The data stored in each block may be simultaneously erased. In one embodiment, the block is the minimum unit of storage elements that are simultaneously erased. In each block, for example, there are columns corresponding to bit lines (e.g., bit lines of 1 KB). In one embodiment referred to as an all bit line (ABL) architecture, all the bit lines of a block may be simultaneously selected during read and program operations. Storage elements along a common word line and connected to all bit lines may be programmed at the same time.

In another embodiment referred to as an odd-even architecture, bit lines are divided into even bit lines (BLe) and odd bit lines (BLo) and separately programmed. In the odd/even bit line architecture, storage elements along a common word line and connected to the odd bit lines are programmed together, while storage elements along a common word line and connected to even bit lines are not programmed. Thereafter, the programming is reversed for the even bit line programming. Data may be programmed into different blocks and read from different blocks concurrently.

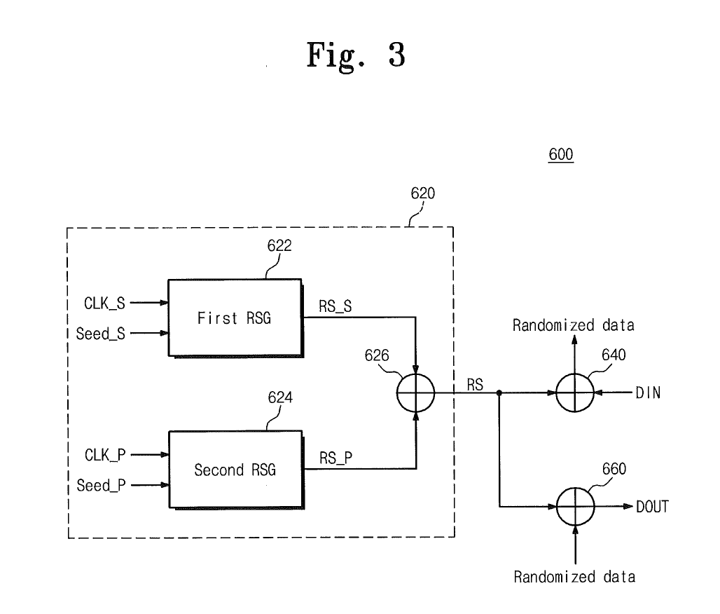

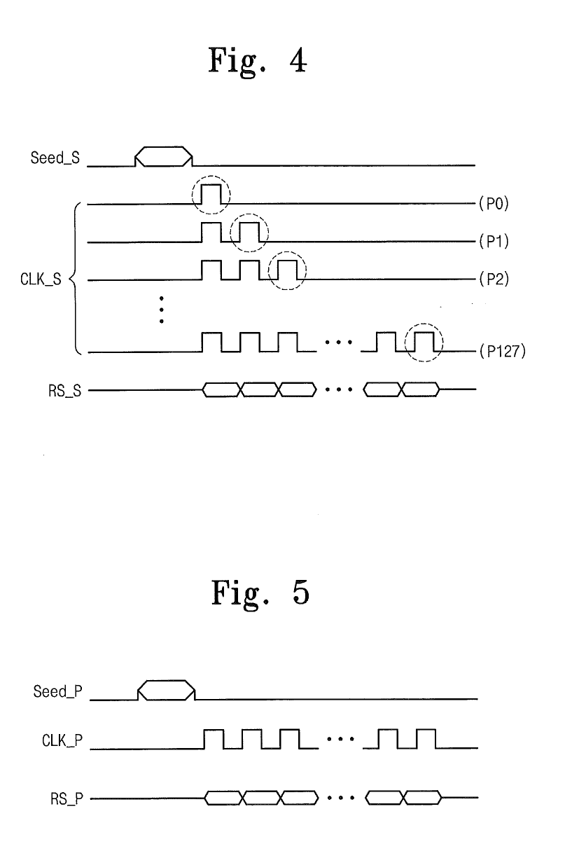

FIG. 3 is a block diagram of a data randomizing and de-randomizing circuit shown in FIG. 1 according to an exemplary embodiment of the inventive concept. FIG. 4 is a timing chart illustrating the operation of a first random sequence generator 622 shown in FIG. 3. FIG. 5 is a timing chart illustrating the operation of a second random sequence generator 624 shown in FIG. 3. Referring to FIG. 3, the data randomizing and de-randomizing circuit 600 may include a random sequence generation unit 620 and first and second XOR units 640 and 660. The random sequence generation unit 620 may be configured to generate a pseudo random sequence RS based on seed values Seed_S and Seed_P. The random sequence RS may be provided to the first and second XOR units 640 and 660. The first XOR unit 640 may combine input data with the random sequence RS during a program operation and output the data combined as randomized data to a column gate circuit 500. The second XOR unit 660 may combine read data transferred through the column gate circuit 500 with the pseudo random sequence RS during a read operation and output the data combined as de-randomized data to an input/output interface 700. This de-randomized data corresponds to the original input data.

The random sequence generation unit 620 may include a first random sequence generator 622, a second random sequence generator 624, and an XOR unit 626. The first random sequence generator 622 may receive the seed value Seed_S and generate a pseudo random sequence RS_S according to toggling of a clock signal CLK_S provided from the control logic 500 shown in FIG. 1. For example, an address for designating a memory block including a selected word line, a constant value or the like may be used as the seed value Seed_S of the first random sequence generator 622. As shown in FIG. 4, the clock signal CLK_S may be toggled as many times as the number corresponding to a selected word line (i.e., a selected page address). Finally, the random sequence RS_S generated by the toggled clock signal CLK_S may be provided to the XOR unit 626. In FIG. 4, random sequences encircled by dotted curves may be finally generated random sequences RS_S, respectively.

Assuming that one memory block includes 64 word lines and each memory cell stores 2-bit data, as shown in FIG. 4, the clock signal CLK_S may be toggled as many times as the number (e.g., 2) corresponding to a selected page (e.g., a second page). Setting the seed value Seed_S to a block address means that a seed value Seed_S of each memory block is differently set in each memory block. In contrast, setting the seed value Seed_S to a constant value means that a seed value Seed_S of each memory block is identically set in all memory blocks.

The second random sequence generator 624 may receive a seed value Seed_P and, as shown in FIG. 5, generate a pseudo random sequence RS_P according to toggling of a clock signal CLK_P provided from the control logic 500 shown in FIG. 1. For example, a page address for designating a page may be used as the seed value Seed_P. The random sequence RS_P generated by the second random sequence generator 624 may be provided to the XOR unit 626. The clock signal CLK_P may be toggled until data to be programmed are all loaded. For example, when 512B-data is loaded, the clock signal CLK_P is toggles 512 times.

In an exemplary embodiment of the inventive concept, the first and second random sequence generators 622 and 624 and the XOR units (or logic units) 626 and 640 may constitute a data randomizer which randomizes data to be programmed to a memory cell array to randomize states of memory cells in row and column directions. The first and second random sequence generators 622 and 624 and the XOR units 626 and 660 may constitute a data de-randomizer.

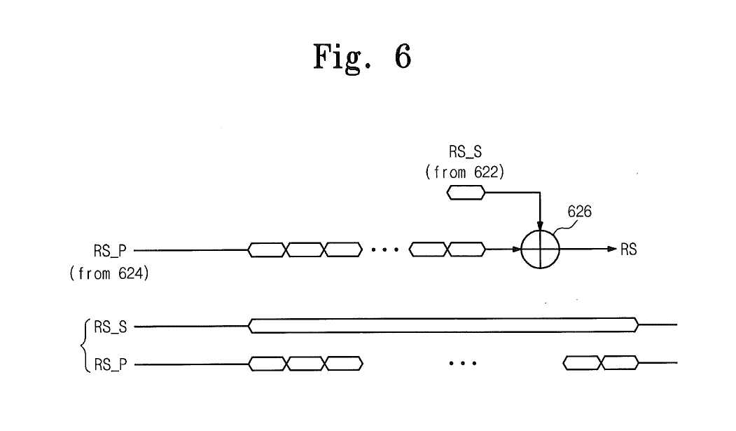

FIG. 6 illustrates the operation of the random sequence generation unit 620 shown in FIG. 3. Referring to FIG. 6, the first random sequence generator 622 may generate a random sequence RS_S before the second random sequence generator 624 generate a random sequence RS_P. The random sequence RS_P may be combined with the random sequence RS_S by the XOR unit 626. As shown in FIG. 6, a value of the random sequence RS_S may be maintained while a value of the random sequence RS_P varies with toggling of a clock signal CLK_P.

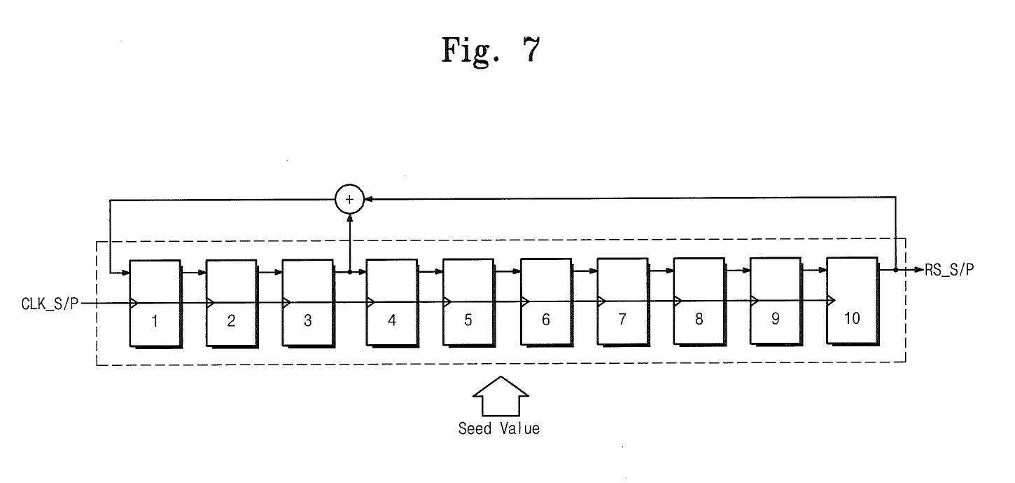

FIG. 7 is a circuit diagram of the first/second random sequence generator 622/624 shown in FIG. 3. Referring to FIG. 7, the first/second random sequence generator 622/624 uses a linear feedback shift register (LFSR) including a shift register and an XOR unit. However, it will be understood that the first/second random sequence generator 622/624 may comprise a PN sequence generator, a CRC generator or the like. The first/second random sequence generator 622/624 generates a random sequence RS_S/P according to a seed value. In an exemplary embodiment of the inventive concept, the random sequence RS_S/P may be 1-bit data. The random sequence RS_S/P may be generated according to the toggling of a clock signal CLK_S/P provided from a control logic 300 shown in FIG. 1 and be provided to an XOR unit 626 shown in FIG. 3.

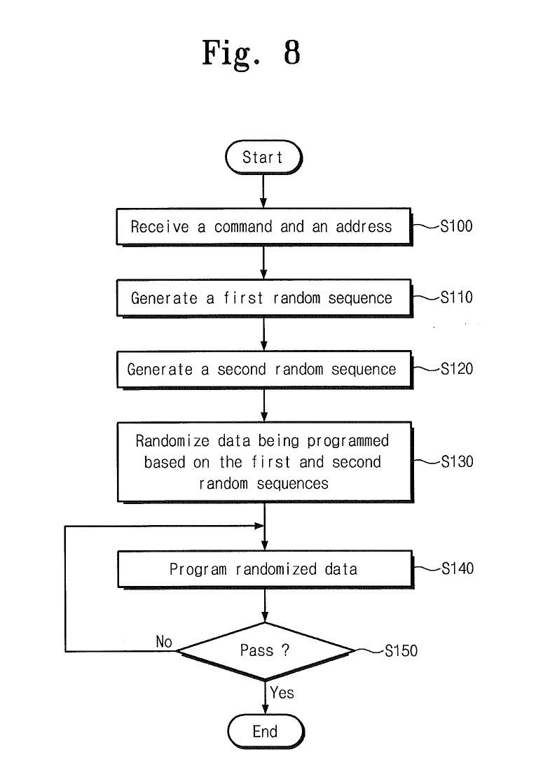

FIG. 8 is a flowchart illustrating a program operation of a flash memory device according to an exemplary embodiment of the inventive concept. The program operation of a flash memory device according to an exemplary embodiment of the inventive concept will now be described more fully with reference to accompanying drawings. If a program operation is started, at S100, a command and an address are provided to a flash memory device. The address may include a block address for selecting a memory block and a page address for selecting word lines belonging to the memory block, i.e., pages. Once the command and the address are provided to the flash memory device, at S110, a first random sequence generator 622 generates a first random sequence RS_S in compliance with the control of a control logic 300. The first random sequence generator 622 may be provided with, for example, a block address as a seed value. However, it will be understood that the first random sequence generator 622 may be provided with a constant value as a seed value. The first random sequence generator 622 may generate a random sequence RS_S according to the toggling of a clock signal CLK_S provided from the control logic 300. The clock signal CLK_S may be toggled as many times as a page address for designating a page to be programmed. The generated first random sequence RS_S may be provided to an XOR unit 626.

At S120, a second random sequence generator 624 generates a second random sequence RS_P in compliance with the control of the control logic 300. The second random sequence generator 624 may be provided with, for example, a gate address as a seed value. The second random sequence generator 624 may generate a random sequence RS_P according to the toggling of a clock signal CLK_P provided from the control logic 300. The clock signal CLK_P may be toggled as many times as a page address for designating a page to be programmed. The generated second random sequence RS_P may be provided to an XOR unit 626. The second random sequence RS_P may be logically combined with the first random sequence RS_S by the XOR unit 626. As set forth above, the first random sequence RS_S may be maintained while the second random sequence RS_P varies with the toggling of the clock signal CLK_P. A result of the combination made by the XOR unit 626 may be provided to an XOR unit 640.

At S130, data to be programmed is approximately randomized based on the first and second random sequences RS_S and RS_P. More specifically, data to be programmed may be provided to the XOR unit 640 through an input/output interface 700. At this point, a result of the combination of the first and second random sequences RS_S and RS_P made by the XOR unit 626, i.e., a random sequence RS may be provided to the XOR unit 640. The data to be programmed may be randomized by the XOR unit 640 according to the result of the combination of the first and second random sequences RS_S and RS_P made by the XOR unit 626, i.e., the random sequence RS. At this point, the randomization of the data to be programmed may be done in row (page) and column (string) directions. The above data randomization procedure may be performed until the data to be programmed are all loaded. The randomized data may be transferred to a page buffer circuit 400 through a column selector 500.

If the data to be programmed are all loaded, at S140, the randomized data is programmed to memory cells belonging to a selected page. At S150, it is determined whether the memory bells belonging to the selected page are programmed to have required states. If they are not programmed to have required state, the flow proceeds to S140. In contrast, if they are programmed to have required state, the flow is terminated.

As set forth above, data to be programmed may be randomized by a first random sequence RS_S for randomization in a column direction (string direction) and a second random sequence RS_P for randomization in a row direction (page direction). Since the data is randomized in not only the column direction but also the row direction, states of memory cells along columns may be approximately uniformly distributed. This means that a back pattern may be identically/similarly formed at each string. Accordingly, a reading margin may be improved.

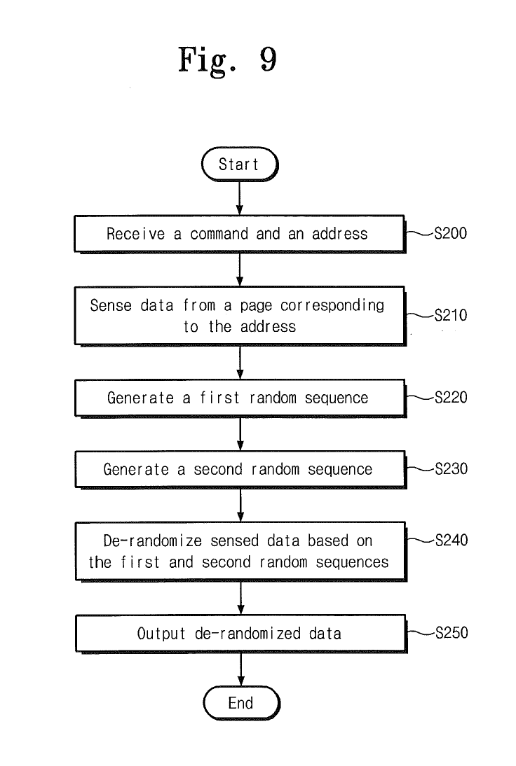

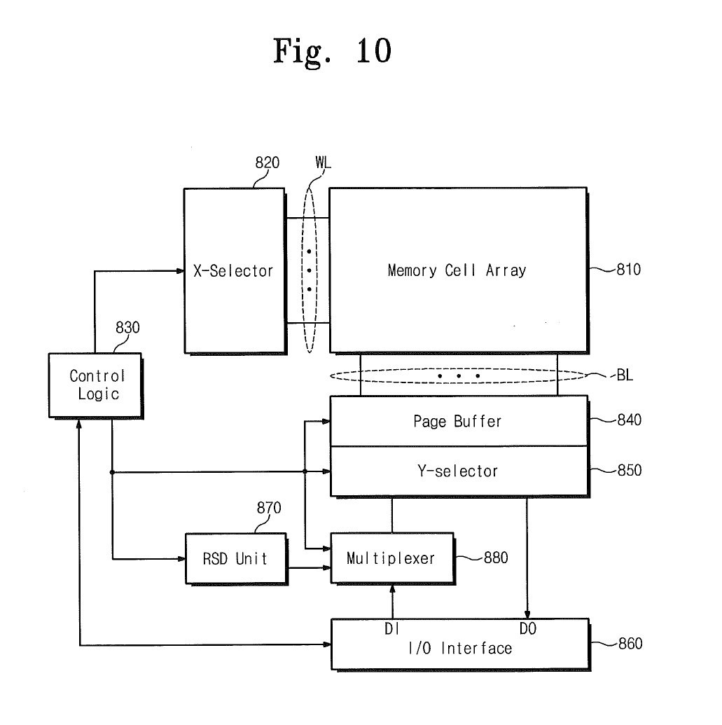

FIG. 9 is a flowchart illustrating a read operation of a flash memory device according to an exemplary embodiment of the inventive concept. The read operation of a flash memory device according to an exemplary embodiment of the inventive concept will now be described more fully with reference to accompanying drawings. If a read operation is started, at S210, a command and an address are provided to a flash memory device. The address may include a block address for selecting a memory block and a page address for selecting word lines belonging to the memory block, i.e., pages. Once the command and the address are provide to the flash memory device, at S210, data is sensed from a page corresponding to an input address by a page buffer circuit 400.

At S220, a first random sequence generator 622 generates a first random sequence RS_S in compliance with the control of a control logic 300. At S230, a second random sequence generator 624 generates a second random sequence RS_P in compliance with the control of the control logic 300. The steps of generating the first and second random sequences RS_S and RS_P are substantially identical to those described in FIG. 8 and will not be described in further detail. As set forth above, the second random sequence RS_P may be logically combined with the first random sequence RS_S by an XOR unit 626. A result RS of the combination made by the XOR unit 626 may be provided to an XOR unit 640. At S240, sensed data may be de-randomized by an XOR unit 660 according to the first and second random sequences RS_S and RS_P. At S250, the de-randomized data is output to an external entity.

Thus, as described hereinabove, memory devices according to some embodiments of the invention include an array of non-volatile memory cells 100, which can be arranged as a plurality of rows of non-volatile memory cells electrically coupled to respective word lines WL and a plurality of columns of non-volatile memory cells electrically coupled to respective bit lines BL, as illustrated by FIGS. 1-2. A memory control circuit (200-700) is also provided, as illustrated by FIG. 1. The memory control circuit (200-700), which is electrically coupled to the array of non-volatile memory cells 100, includes a pseudo-random data coder/decoder circuit 600. This pseudo-random data coder/decoder circuit 600 is configured to convert a first block of input data to be written into the memory device into a second block of data. This second block of data is encoded as a two-dimensional pseudo-random distribution of data values, which are more uniformly distributed relative to data values in the first block of input data. The memory control circuit is further configured to write the second block of data into the array of non-volatile memory cells 100 during a plurality of page write operations. The pseudo-random data coder/decoder circuit 600 is further configured to convert the second block of data having a two-dimensional pseudo-random distribution of data values into a first block of output data during a plurality of page read operations. This first block of output data matches the first block of input data.

As illustrated by FIGS. 3-6, the pseudo-random data coder/decoder circuit 600 includes a pseudo-random sequence generator 620, which is configured to generate a pseudo-random sequence of encoding bits RS. In particular, the pseudo-random data coder/decoder circuit 600 is configured to logically combine the pseudo-random sequence of encoding bits RS with a sequence of bits of data within the first block of input data (DIN) during the plurality of page write operations. This logical combination may be performed using an XOR logic circuit 640, for example. The pseudo-random sequence generator 620 may include first and second pseudo-random sequence generators 622, 624. The first pseudo-random sequence generator 622 is configured to generate a first pseudo-random sequence of bits RS_S in response to a first clock signal CLK_S and a first multi-bit seed value SEED_S. The second pseudo-random sequence generator 624 is configured to generate a second pseudo-random sequence of bits RS_P in response to a second clock signal CLK_P and a second multi-bit seed value SEED_P. A combinational logic circuit is also configured to generate the pseudo-random sequence of encoding bits RS in response to the first and second pseudo-random sequence of bits. This combinational logic circuit can be an XOR logic circuit 626, which receives the first and second pseudo-random sequence of bits RS_S, RS_P at inputs thereof.

As illustrated by FIG. 7, the first and second pseudo-random sequence generators may include a respective linear feedback shift registers that are synchronized with the clock signal CLK_S/P. This first pseudo-random sequence generator 622 may be configured to load the first multi-bit seed value SEED_S into the first linear feedback shift register during generation of the first pseudo-random sequence of bits RS_S. Similarly, the second pseudo-random sequence generator 624 may include a second linear feedback shift register, which is loaded with the second multi-bit seed value SEED_P during generation of the second pseudo-random sequence of bits RS_P.

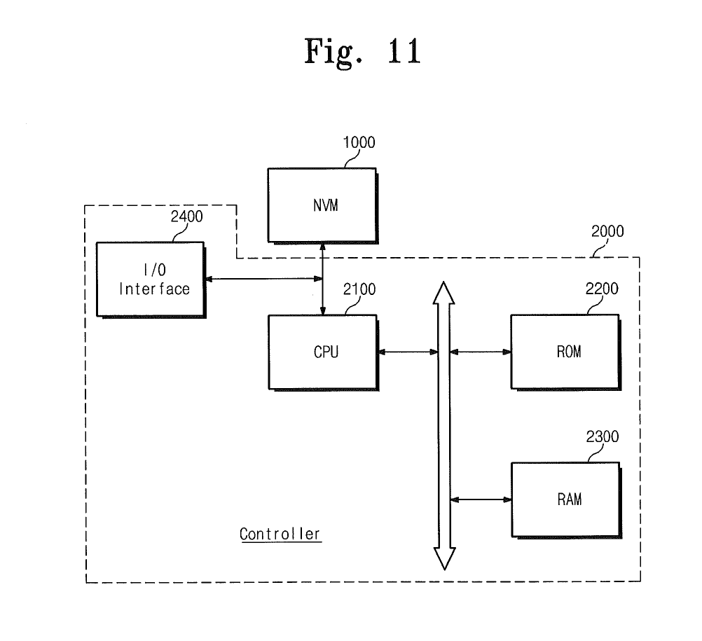

FIG. 10 is a block diagram of a flash memory device according to another exemplary embodiment of the inventive concept. Referring to FIG. 10, a flash memory device according to another exemplary embodiment of the inventive concept is, for example, a NAND flash memory device. The flash memory device includes a memory cell array 810 including memory cells arranged in a matrix of rows (word lines WL) and columns (bit lines BL). Each of the memory cells stores 1-bit data or M-bit (multi-bit) data (M being 2 or greater integer). Each of the memory cells may be configured using a memory cell including a charge storage layer such as a floating gate or a charge trapping layer or a memory cell including a variable resistance element. The memory cell array 810 may be configured to have a single-layer array structure (or called a two-dimensional array structure) or a multi-layer array structure (or called a three-dimensional array structure).

A row selector (X-Selector) 820 is controlled by a control logic 830 and configured to perform selecting and driving operations for rows of the memory cell array 810. The control logic 830 is configured to control an overall operation of the flash memory device and functions as a sense amplifier or a write driver according to an operation mode. For example, during a read operation, a page buffer circuit 840 functions as a sense amplifier sensing data from memory cells of a selected row. During a program operation, the page buffer circuit 840 functions as a write driver driving memory cells of a selected row according to program data. The page buffer circuit 840 includes page buffers each corresponding to each of bit lines or bit line pairs. When respective memory cells store multi-bit data, respective page buffers of the page buffer circuit 840 may be configured to have two or more latches.

Continuing to refer to FIG. 10, a column selector (Y-selector) 850 is controlled by the control logic 830 and selects columns (or page buffers) in a predetermined sequence during a read/write operation. An input/output interface 860 outputs data of the page buffer circuit 840 transferred from through column selector 850 to an external entity (e.g., a memory controller). A random sequence generation unit 870 is controlled by the control logic 830 and sequentially generates random sequence data (RSD). The sequence generation unit 860 shown in FIG. 10 is organized with the same structure as that shown 3 and will not be described in further detail. A multiplexer 880 operates in response to the control of the control logic 830. The multiplexer 880 transfers an output of the input/output interface 860 to the column selector 850 for a data loading period. When the data loading period is completed, the multiplexer 880 transfers an output of the random sequence generation unit 870 to the column selector 850.

The page buffer circuit 840 is configured to receive data to be programmed for the data loading period and receive a random sequence after the data loading period is completed. This means that each page buffer of the page buffer circuit 840 includes a latch storing program data and a latch storing a random sequence. The page buffer circuit 840 performs a bit-wise XOR operation for the input program data and random sequence data in compliance with the control of the control logic 830. Thus, the program data is randomized. Each page buffer of the page buffer circuit 840 may further include a latch storing randomized data. Alternatively, each page buffer of the page buffer circuit 840 may be configured to store randomized data in the latch storing program data. To achieve this, each page buffer may be configured to perform a logical function such as an XOR operation.

Similar to the program operation, a bit-wise XOR operation of each page buffer may also be performed when a read operation is performed. While data is sensed, the random sequence generated by the random sequence generation unit 870 is loaded to the page buffer 840. When the data sensing operation is completed, the page buffer circuit 840 performs a bit-wise XOR operation for the sensed data and random sequence data in compliance with the control of the control logic 830. Thus, the sensed data is de-randomized (or restored to original data). The de-randomized data may be output to an external entity through the input/output interface 860.

Similar to the description made with reference to FIG. 1, the program data may be randomized in row and column directions according to a random sequence generated by the random sequence generation unit 870. In other words, the program data may be randomized in row and column directions by means of a random sequence generating method according to the inventive concept, irrespective of locations of data randomization.

FIG. 11 is a block diagram of an integrated circuit card including a flash memory device according to an exemplary embodiment of the inventive concept. Referring to FIG. 11, an integrated circuit card (e.g., smart card) includes a nonvolatile memory device 1000 and a controller 2000. The nonvolatile memory device 1000 is substantially identical to that shown in FIG. 1 or FIG. 10 and will not be described in further detail. The controller 2000 controls the nonvolatile memory device 1000 and includes a central processing unit (CPU) 2100, a read only memory (ROM) 2200, a random access memory (RAM) 2300, and an input/output interface 2400. The CPU 2100 controls an overall operation of the integrated circuit card, based on various programs stored in the ROM 2200, and provides an interface with an external device.

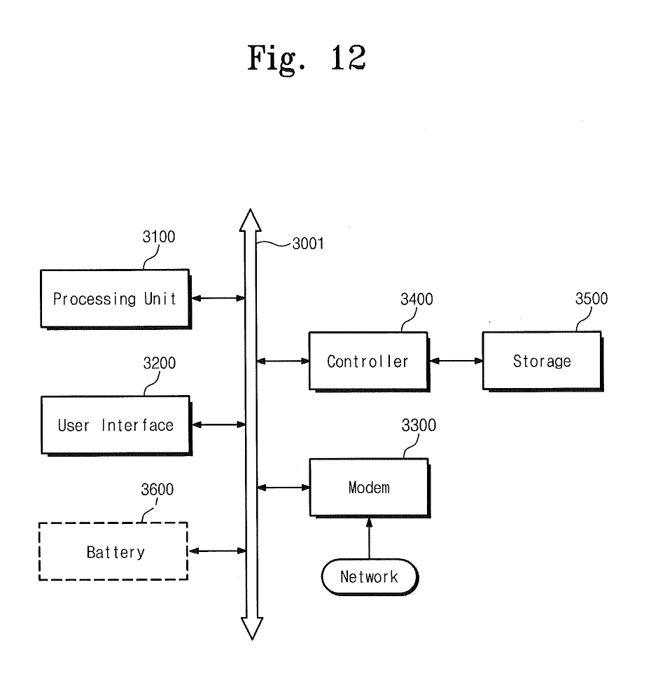

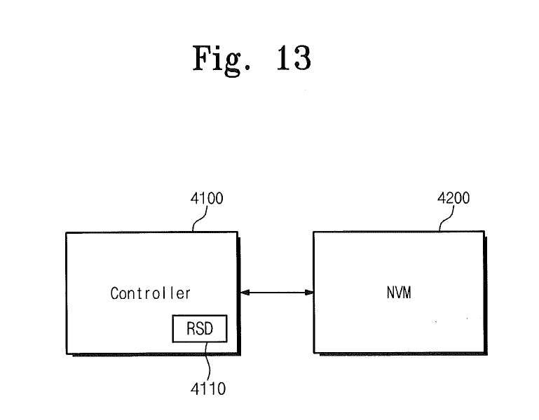

A flash memory device is a nonvolatile memory device which is capable of retaining its stored data even when its power supply is interrupted. A flash memory device is widely used as not only data storage but also code storage in mobile devices such as cellular phones, PDAs, digital cameras, portable game consoles, and MP3 players. Moreover, a flash memory device may also be used in home applications such as HDTV, DVD, router, and GPS devices. A computing system including a flash memory device according to an exemplary embodiment of the inventive concept is illustrated in FIG. 12.

The computing system according to the inventive concept include a microprocessor 3100, a user interface 3200, a modem 3300 such as a baseband chipset, a memory controller 3400, and a flash memory device 3500 functioning as a storage medium, which are be electrically connected to a bus 3001. The flash memory controller 3500 may be organized with the same structure as shown in FIG. 1 or FIG. 10. N-bit data processed/to be processed (N being 1 or greater integer) by the microprocessor 3100 may be stored in the flash memory device 3500 through the memory controller 3400. In the case where the computing system is a mobile device, a battery 3600 for supplying an operation voltage to the computing system may be provided. Although not shown in the drawings, it is apparent to those skilled in the art that an application chipset, camera image processor (CIS), and mobile DRAM may be further provided in the computing system. A memory controller and a flash memory device may constitute a solid state drive/disk (SSD) using a nonvolatile memory to store data.

FIG. 13 is a block diagram of a memory system according to another embodiment of the inventive concept. Referring to FIG. 13, a memory system may include a controller 4100 and a nonvolatile memory device 4200. The controller 4100 may be configured to control the nonvolatile memory device 4200. Particularly, the controller 4100 may be configured to randomize data to be stored in the nonvolatile memory device 4200. To achieve this, a random sequence generation unit 4110 may be provided in the controller 4100. The random sequence generation unit 4110 is substantially identical to the random sequence generation unit 620 shown in FIG. 3. An address provided to the random sequence generation unit 4110 may be a logical address provided from a host or a physical address generated from the controller 4100. Although not shown in the drawings, it will be understood that the controller 4100 may further include a host interface providing an interface with a host, a memory interface providing an interface with the nonvolatile memory device 4200, a buffer memory, an ECC, a processing unit, a ROM, and so forth.

A flash memory device or a memory controller according to the inventive concept may be packaged using various types of packages. For example, a flash memory device or memory controller according to the inventive concept may be packaged using packages such as PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

In an exemplary embodiment of the inventive concept, memory cells may be realized using one of the various memory cell structures that include charge storage layers. The cell structure including the charge storage layer may include a charge trap flash structure that uses a charge trapping layer, a stack flash structure in which arrays are stacked in multi-layers, a flash structure without a source-drain, or a pin-type flash structure.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description. Moreover, the terms random, randomization and randomized include pseudo-random data strings and pseudo-randomizing operations as will be understood by those skilled in the art.

1. A memory device, comprising:
an array of non-volatile memory cells arranged as a plurality of rows of non-volatile memory cells electrically coupled to respective word lines and a plurality of columns of non-volatile memory cells electrically coupled to respective bit lines; and
a memory control circuit electrically coupled to said array of non-volatile memory cells, said memory control circuit comprising a pseudo-random data coder/decoder circuit configured to convert a first block of input data to be written into the memory device into a second block of data that is encoded as a two-dimensional pseudo-random distribution of data values.

2. The memory device of claim 1, wherein said memory control circuit is configured to write the second block of data into said array of non-volatile memory cells during a plurality of page write operations.

3. The memory device of claim 2, wherein the pseudo-random data coder/decoder circuit is further configured to convert the second block of data having a two-dimensional pseudo-random distribution of data values into a first block of output data during a plurality of page read operations.

4. The memory device of claim 3, wherein the pseudo-random data coder/decoder circuit comprises a pseudo-random sequence generator configured to generate a pseudo-random sequence of encoding bits; and wherein the pseudo-random data coder/decoder circuit is configured to logically combine the pseudo-random sequence of encoding bits with a sequence of bits of data within the first block of input data during the plurality of page write operations.

5. The memory device of claim 4, wherein the pseudo-random data coder/decoder circuit is configured to logically combine the pseudo-random sequence of encoding bits with the sequence of bits of data within the first block of input data using an XOR logic circuit.

6. The memory device of claim 4, wherein the pseudo-random sequence generator comprises:
a first pseudo-random sequence generator configured to generate a first pseudo-random sequence of bits in response to a first clock signal and a first multi-bit seed value;
a second pseudo-random sequence generator configured to generate a second pseudo-random sequence of bits in response to a second clock signal and a second multi-bit seed value; and
a combinational logic circuit configured to generate the pseudo-random sequence of encoding bits in response to the first and second pseudo-random sequence of bits.

7. The memory device of claim 6, wherein the combinational logic circuit is an XOR logic circuit.

8. A flash memory device comprising:
a memory cell array having memory cells arranged in a matrix of rows and columns; and
a random sequence generation circuit generating a random sequence of data to be programmed to the memory cell array such that states of the memory cells are randomized in row and column directions.

9. The flash memory device as set forth in claim 8, wherein:
the random sequence generation circuit is configured to generate the random sequence based on a first seed value for randomization in the column direction and a second seed value for randomization in the row direction.

10. The flash memory device as set forth in claim 9, wherein:
the random sequence generation circuit is configured to generate a first random sequence according to the first seed value and generate a second random sequence according to the second seed value,
the data to be programmed to the memory cell array is randomized based on the first and second random sequences, and
the first random sequence is generated ahead of the second random sequence.

11. The flash memory device as set forth in claim 10, wherein:
a value of the first random sequence varies during variation of the second random sequence, and
the data programmed to the memory cell array is randomized according a random sequence generated by an exclusive OR (XOR) operation of the first and second random sequences.

12. The flash memory device as set forth in claim 9, wherein:
the first seed value is either one of a block address and a constant value, and the second seed value is a page address.

13. A flash memory device comprising:
a memory cell array including memory cells arranged in a matrix of rows and columns;
a first random sequence generator configured to generate a first random sequence in response to a first seed value for randomization in a string direction;
a second random sequence generator configured to generate a second random sequence in response to a second seed value for randomization in a page direction; and
a logic unit configured to logically combine the first random sequence with the second random sequence,
wherein data to be programmed to the memory cell array is randomized according to an output of the logic unit.

14. The flash memory device as set forth in claim 13, wherein:
the first seed value is either one of a block address and a constant value, and the second seed value is a page address.

15. The flash memory device as set forth in claim 14, wherein:
the first random sequence generator operates in response to a first clock signal, and the second random sequence generator operates in response to a second clock signal, and
the first clock signal is toggled as many times as the page address, and the second clock signal is toggled after the toggling of the first clock signal is completed.

16. The flash memory device as set forth in claim 15, wherein:
a value of the first random sequence generated according to the final toggling of the first clock signal does not vary while a value of the second random sequence varies with the toggling of the second clock signal.

17. The flash memory device as set forth in claim 13, wherein:
when states of the memory cells are randomized in the string and page directions, states of memory cells belonging to back patterns of selected memory cells are uniformly distributed.

18. The flash memory device as set forth in claim 13, further comprising:
a second logic unit configured to randomize the data to be programmed to the memory cell array according to an output of the logic unit; and
a third logic unit configured to de-randomize data read from the memory cell array according to an output of the logic unit.

19. The flash memory device as set forth in claim 13, further comprising:
a page buffer circuit configured to temporarily store the data to be programmed to the memory cell array, the page buffer circuit being configured to randomize the data to be programmed according to an output of the logic unit.

20. The flash memory device as set forth in claim 19, wherein:
the page buffer circuit is configured to de-randomize the randomized data read from the memory cell array according to the output of the logic unit during a read operation.

21.-27. (canceled)
